(19) United States
(12) Patent Application Publication
(10) Pub. No.: US 2015/0213306 A1
(43) Pub. Date: Jul. 30, 2015

(54) APPARATUS, METHOD AND SYSTEM FOR AUTOMATICALLY DETECTING QUESTIONABLE PERSONS

(71) Applicant: Chiun Mai Communication Systems, Inc., New Taipei (TW)

(72) Inventor: JIUN-RU HOU, New Taipei (TW)

(21) Appl. No.: 14/540,688

(22) Filed: Nov. 13, 2014

(30) Foreign Application Priority Data
Jan. 25, 2014 (CN) 201410036942.5

(51) Int. Cl. G06K 9/00; H04N 7/18

(52) U.S. Cl. CPC G06K 9/00288; H04N 7/183

(57) ABSTRACT

An apparatus, method, and system for automatically detecting the presence of questionable persons include receiving the geographical location of a user from a GPS unit and pictorial information relating to scenes behind user from a camera, executing face recognition technologies to capture human face in the scenes, recording a length of time each human face appears in the scenes, marking a human face as dangerous if the length of time exceeds a predetermined threshold, saving the pictures of dangerous human face in a storage unit, and issuing an alarm notification and transmitting the dangerous human face and the geographical location of the user to a local police office if a distance of the dangerous human increases by a predetermined distance threshold.

### CROSS-REFERENCE TO RELATED APPLICATIONS

This application claims priority to Chinese Patent Application No. 201410036942.5 filed on Jan. 25, 2014 in the China Intellectual Property Office, the contents of which are incorporated by reference herein.

### FIELD

The subject matter herein generally relates to personal security.

### BACKGROUND

Smart wearable devices are generally eyeglasses, gloves, watches, clothes, and shoes. Many tech companies such as Google, Apple, Microsoft, Sony, and Olympus have begun deeper discoveries in this new field.

In general, the electronic fetters worn by criminals might be detected on a mobile phone. Although a mobile phone might detect people who have criminal records, lots of potential criminals do not have criminal records and they do not wear electronic fetters. Therefore, potential criminals cannot be detected by mobile phones.

### BRIEF DESCRIPTION OF THE DRAWINGS

Implementations of the present technology will now be described, by way of example only, with reference to the attached figures.

FIG. 1 is a block diagram of a detection and warning system in one embodiment.

FIG. 2 is a block diagram of an example functional module of the control unit of the detection and warning system of FIG. 1.

FIG. 3 is a flowchart of an embodiment of a method of the detection and warning system of FIG. 1.

FIG. 4 is a view of the detection and warning system when the present embodiment is installed on eyeglasses.

FIG. 5 is a view of the detection and warning system of FIG. 1 when an embodiment is installed on belts.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like. The term “module” in the present invention can be a hardware chip made up of a plurality of electronic components or a computer program consisting of a series of executable instructions.

The present disclosure is described in relation to an apparatus, a method, and a system for automatically detecting questionable persons.

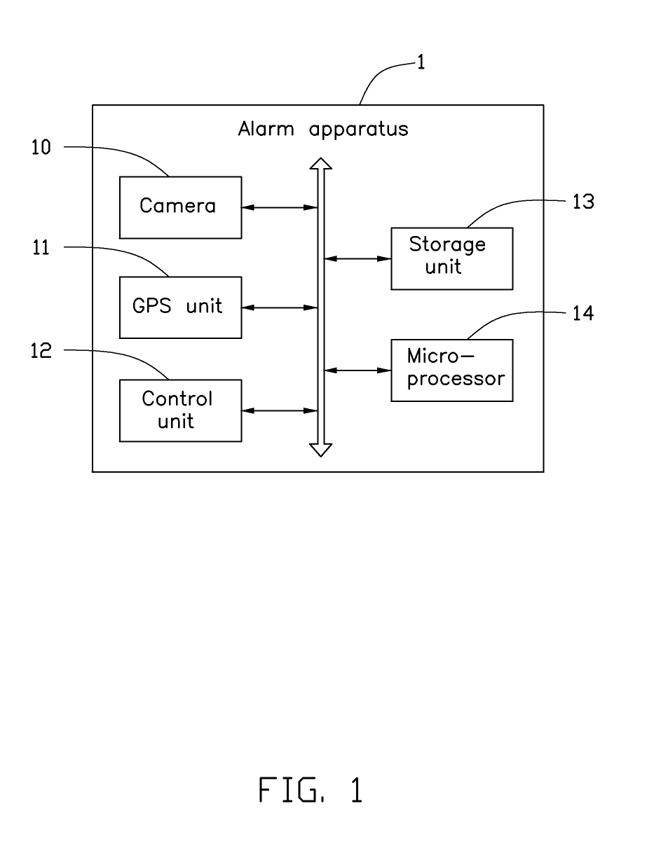

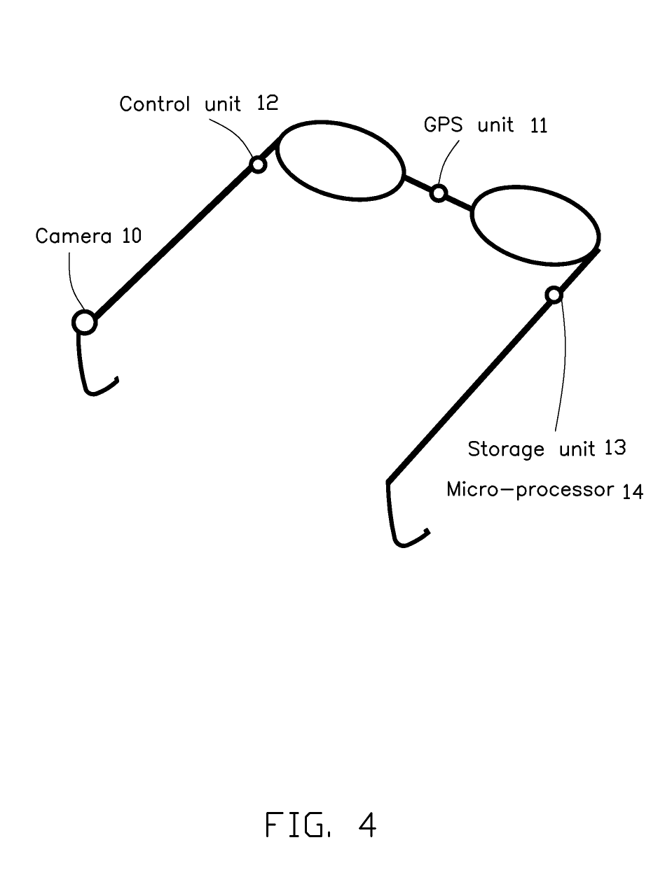

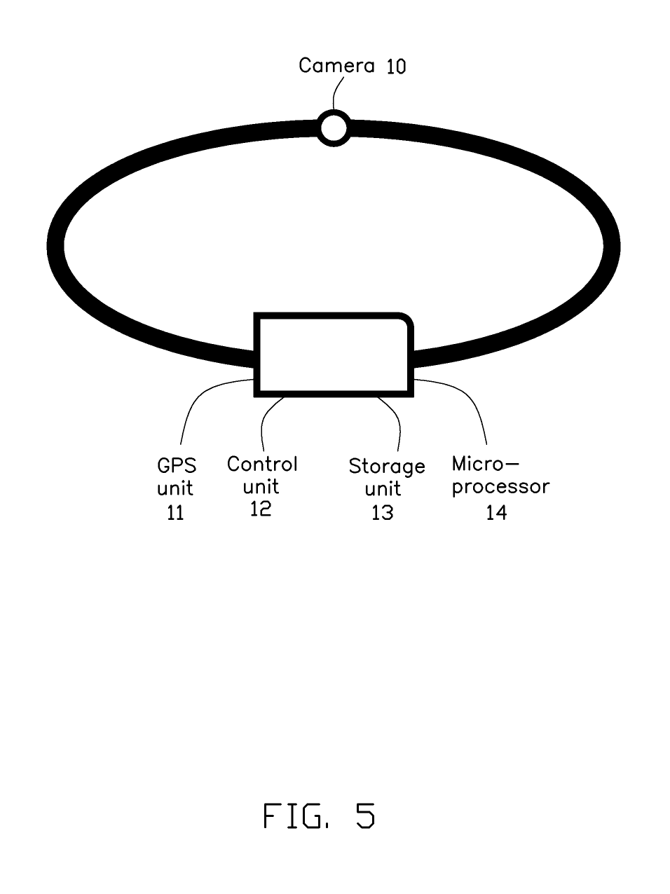

FIG. 1 illustrates an alarm apparatus 1 which includes, but is not limited to, a camera 10, a GPS (Global Positioning System) unit 11, a control unit 12, a storage unit 13, a micro-processor 14, and interface connecting circuits. The alarm apparatus 1 can be installed on eyeglasses (see FIG. 4) or on belts (see FIG. 5). Referring to FIG. 4, the camera 10 can be installed on the rear of the frame of the eyeglasses and is used for taking images of the scene behind a user in real-time. The GPS unit 11 can be installed on the bridge of the eyeglasses and is used for establishing the geographical location of the user in real-time. The control unit 12, the storage unit 13, and the micro-processor 14 can be installed on other parts of the frame of the eyeglasses. Each unit is coupled electronically. As shown in FIG. 5, the camera 10 can be installed on a belt and is used for detecting scenes behind a user. The GPS unit 11, the control unit 12, the storage unit 13, and the micro-processor 14 can be installed on the belt buckle. Each unit is coupled electronically.

The camera 10 is used for taking pictures of human faces behind the user. The number of times each human face appears behind the user is recorded. The GPS unit 11 incorporates existing GPS technologies to establish the geographical location of the user in real-time.

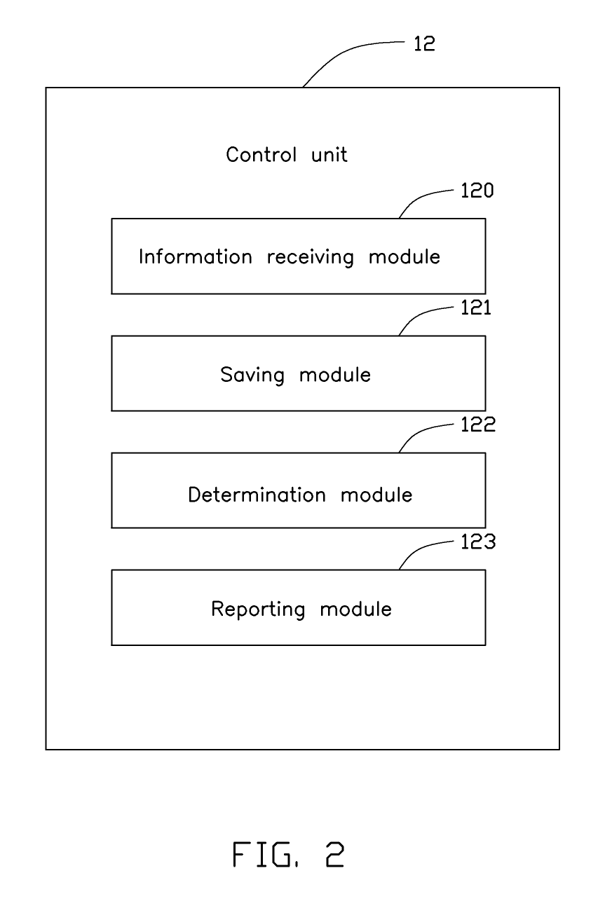

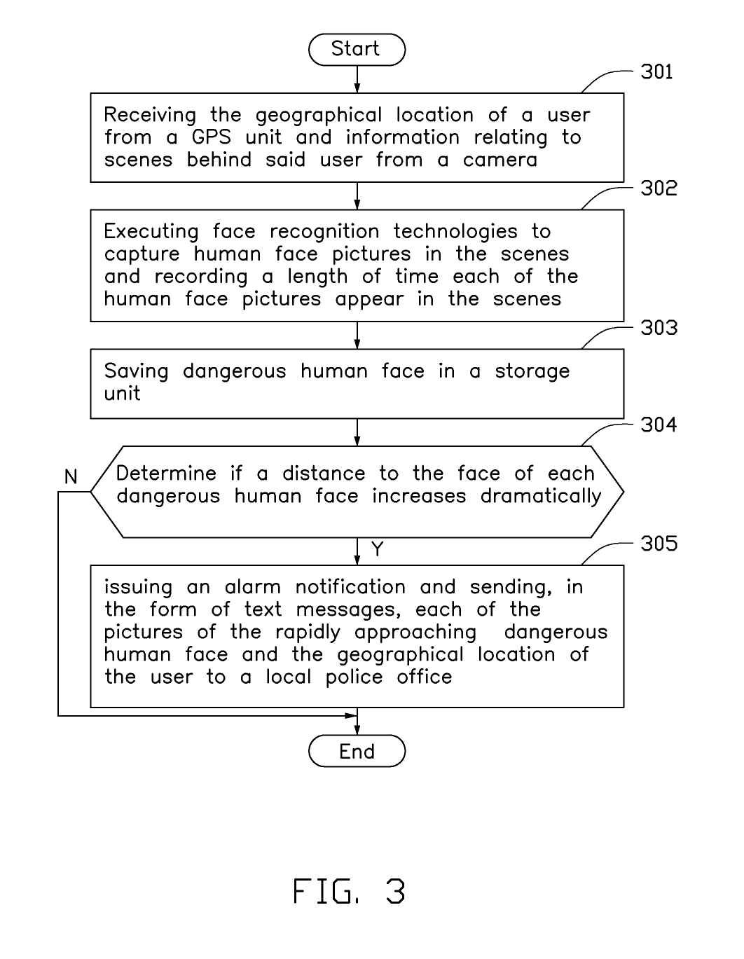

FIG. 2 illustrates example functional modules of the control unit 12 of the alarm apparatus 1. In one embodiment, the control unit 12 includes an information receiving module 120, a saving module 121, a determination module 122, and a reporting module 123. Each module is a computer program that can be executed to accomplish certain functions by the micro-processor 14 of the alarm apparatus 1. Each module is stored in the storage unit 13 of the alarm apparatus 1. The control unit 12 can be an IC (Integrated Circuit) chip that implements above functions. The function of each module is described with reference to FIG. 3.

Referring to FIG. 3, an embodiment of a flowchart is presented. The method is provided by way of example, as there are a variety of ways to carry out the method. The method described below can be carried out using the configurations illustrated in FIGS. 1 and 2, for example, and various elements of these figures are referenced in explaining method. Each block shown in FIG. 3 represents one or more processes, methods, or subroutines, carried out in the method. Furthermore, the illustrated order of blocks is illustrative only and the order of the blocks can change. Additional blocks can be added or fewer blocks may be utilized without departing from this disclosure. The method can begin at block 301.

At block 301, the information receiving module 120 receives the geographical location of the user from the GPS unit 11 and information relating to scenes behind the user from the camera unit 10. In the embodiment, when the user turns on the switch of the alarm apparatus 1, the camera 10 starts to take images.

At block 302, the information receiving module 120 executes face recognition technologies to pictures of the scenes and records a length of time each of the human face appear in the scenes. The face recognition technologies are existing technologies which perform identity recognition based on, for example, human facial features. Using cameras or webcams to collect pictures or videos of human faces, face detection and tracking algorithms can be applied to the collected pictures or video streams. After human faces are located, face recognition technologies such as human face pre-processing, storing, and matching can be used to recognize the identities of people.

At block 303, the saving module 121 saves dangerous human face in the storage unit 13. The “dangerous” refers to faces which appear in the scenes for more than five minutes or other predetermined threshold. In the embodiment, when the information receiving module 120 captures each human face picture in the scenes, it records the length of time each human face are present in the scenes. If the total length of time a human face appears in the scenes exceeds five minutes or other predetermined threshold, it marks the human face as dangerous. The saving module 121 then saves the pictures of the dangerous human face in the storage unit 13.

At block 304, the determination module 122 determines if a distance to the face of each dangerous human face increases dramatically. In the embodiment, the distance to the face of a dangerous human face is an average over measured face distances, where the measured face distance is the size of a bounding box around a detected and pictured human face. In the embodiment, if the distance is doubled or multiplied by n times within five seconds or other predetermined period, the method advances to block 305 because it indicates a dangerous human is rapidly approaching the user. Otherwise, the process terminates.

At block 305, the reporting module 123 issues an alarm notification and sends, in the form of text messages, each of the pictures of the rapidly approaching dangerous human face stored in the storage unit 13 and the geographical location of the user positioned by the GPS unit 11 to a local police office.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including, the full extent established by the broad general meaning of the terms used in the claims.

What is claimed is:

1. An alarm apparatus for automatically detecting questionable persons, comprising:
a camera, configured to take scenes behind a user;
a GPS (Global Positioning System) unit, configured to calculate a geographical location of the user;
a storage unit, configured to store dangerous human face;
a control unit configured to:
execute facial recognition technologies to capture human faces in the scenes behind the user and for recording a length of time each of the human faces appear in the scenes;
mark the human face as a dangerous human face if the length of time exceeds a predetermined threshold and the control unit configured to store the dangerous human face in the storage unit; and
issue an alarm notification to the user; the control unit configured to transmit the dangerous human face and the geographical location of the user to a local police office if a distance of the dangerous human face increases by a predetermined distance threshold.

2. The alarm apparatus of claim 1, wherein the distance is an average of measured face distances of the dangerous human face in the length of time.

3. The alarm apparatus of claim 2, wherein the measured face distance is the size of a bounding box indicating a human face picture has been detected.

4. The alarm apparatus of claim 1, wherein a distance of the dangerous human face increases by a predetermined distance threshold means the distance is doubled or multiplied by n times within a predetermined period.

5. An alarm method for automatically detecting questionable persons comprising:
receiving a geographical location of a user from a GPS unit and information relating to scenes behind the user from a camera;
executing face recognition technologies to capture human face pictures in the scenes;
recording a length of time each of the captured human face pictures are present in the scenes;
flagging the captured human face pictures as dangerous human face if the length of time exceeds a predetermined threshold;
storing the dangerous human face in a storage unit; and
issuing an alarm notification to the user;
transmitting the dangerous human face and the geographical location of the user to a local police office if a distance of the dangerous human face increases by a predetermined distance threshold.

6. The alarm method of claim 5, wherein the distance is an average of measured face distances of the dangerous human face in the length of time.

7. The alarm method of claim 6, wherein said measured face distance is the size of a bounding box indicating a human face picture has been detected.

8. The alarm method of claim 5, wherein a distance of the dangerous human face increases by a predetermined distance threshold means the distance is doubled or multiplied by n times within a predetermined period.

9. An alarm system applied in wearable accessories for automatically detecting questionable persons, comprising:
a camera, configured to take scenes behind a user;
a GPS(Global Positioning System) unit, configured to calculate a geographical location of the user;
a storage unit, configured to store dangerous human face;
a control unit configured to receive:
the geographical location of the user from the GPS unit and the scenes behind the user from the camera;
the control unit further configured to execute facial recognition technologies to capture human faces in the scenes behind the user and to record a length of time each of the human faces appear in the scenes; and the control unit configured to mark the human face as a dangerous human face if the length of time exceeds a predetermined threshold;
the control unit configured to store the dangerous human face in the storage unit;
the control unit configured to issue an alarm notification to the user; the control unit configured to transmit the dangerous human face and the geographical location of the user to a local police office if a distance of the dangerous human face increases by a predetermined distance threshold.

10. The alarm system of claim 9, wherein the distance is an average of measured face distances of the dangerous human face in the length of time.

11. The alarm system of claim 10, wherein the measured face distance is the size of a bounding box indicating a human face picture has been detected.

12. The alarm system of claim 9, wherein a distance of the dangerous human face increases by a predetermined distance threshold means the distance is doubled or multiplied by n times within a predetermined period.

13. The alarm system of claim 9, wherein said wearable accessories include eyeglasses or belts.
